(19) United States
(12) Patent Application Publication
(10) Pub. No.: US 2022/0269649 A1
(43) Pub. Date: Aug. 25, 2022

(54) APPLICATION PROGRAM INTERFACE FOR HIERARCHICAL DATA FILES

(71) Applicant: Microsoft Technology Licensing, LLC, Redmond, WA (US)

(72) Inventors: Ghania A. MOUSSA, Sammamish, WA (US); Mehmet Kadri UMAY, Redmond, WA (US); Imran SIDDIQUE, Bellevue, WA (US)

(73) Assignee: Microsoft Technology Licensing, LLC, Redmond, WA (US)

(21) Appl. No.: 17/241,918

(22) Filed: Apr. 27, 2021

Related U.S. Application Data
(60) Provisional application No. 63/153,889, filed on Feb. 25, 2021.

(51) Int. Cl. G06F 16/14; G06F 16/174; G06F 16/172; G06F 16/185; G06F 16/22

(52) U.S. Cl. CPC G06F 16/148; G06F 16/156; G06F 16/1752; G06F 16/172; G06F 16/185; G06F 16/2219

(57) ABSTRACT

A server computing device including a processor. The processor may be configured to, via an application program interface (API), receive a hierarchical data file including a plurality of datasets that are hierarchically organized in a plurality of dataset groups. The processor may be further configured to assign respective dataset metadata to the datasets and respective dataset group metadata to the dataset groups. The processor may be further configured to store, in memory, the plurality of datasets, the dataset metadata, and the dataset group metadata. The processor may be further configured to, via the API, receive a dataset query from a client computing device. The processor may be further configured to perform a search over the dataset metadata and/or the dataset group metadata to thereby generate search results. The processor may be further configured to transmit the search results to the client computing device via the API.

### CROSS REFERENCE TO RELATED APPLICATIONS

This application claims priority to U.S. Provisional Patent Application Ser. No. 63/153,889, filed Feb. 25, 2021, the entirety of which is hereby incorporated herein by reference for all purposes.

### BACKGROUND

In certain applications such as satellite imaging that generate large amounts of data generated through the use of imaging sensors and other sensors, the generated data are frequently stored in hierarchical data files. These hierarchical data files have so-called “filesystem-in-file” structures in which sensor data and categorization information for the sensor data are stored together in the same file. For example, the categorization information for the sensor data may indicate the respective sensors in a sensor array from which data points are received. As another example, the categorization information may indicate a plurality of time intervals in which the sensor data was collected.

### SUMMARY

According to one aspect of the present disclosure, a server computing device including a processor is provided. In a dataset ingestion phase, the processor may be configured to, via an application program interface (API), receive a hierarchical data file including a plurality of datasets that are hierarchically organized in a plurality of dataset groups. The processor may be further configured to assign respective dataset metadata to the plurality of datasets and respective dataset group metadata to the plurality of dataset groups. The processor may be further configured to store, in memory, the plurality of datasets, the dataset metadata, and the dataset group metadata. In a dataset query phase, the processor may be further configured to, via the API, receive a dataset query from a client computing device. In response to receiving the dataset query, the processor may be further configured to perform a search over the dataset metadata and/or the dataset group metadata to thereby generate search results. In response to generating the search results, the processor may be further configured to transmit the search results to the client computing device via the API.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a server computing device configured to receive a hierarchical data file from a client computing device, according to one example embodiment.

FIG. 2 shows an example hierarchical organization of the hierarchical data file, according to the example of FIG. 1.

FIG. 3 schematically shows the server computing device and the client computing device when the server computing device receives the hierarchical data file in a plurality of hierarchical data file chunks, according to the example of FIG. 1.

FIG. 4 schematically shows the server computing device and the client computing device when the server computing device receives a dataset query from the client computing device, according to the example of FIG. 1.

FIG. 5 shows an example filesystem view of the hierarchical data file displayed in a graphical user interface (GUI), according to the example of FIG. 1.

FIG. 6A shows a flowchart of an example method for use with a server computing device, according to the example of FIG. 1.

FIG. 6B shows additional steps of the method of FIG. 6A that may be performed in some examples during a dataset ingestion phase.

FIG. 6C shows additional steps of the method of FIG. 6A that may be performed in some examples during an uploading iteration in which a hierarchical data file chunk is received.

FIG. 7 shows a flowchart of an example method for use with a client computing device, according to the example of FIG. 1.

FIG. 8 shows a schematic view of an example computing environment in which the server computing device of FIG. 1 may be enacted.

### DETAILED DESCRIPTION

Typically, when a user wishes to analyze a portion of the data stored in a hierarchical data file, the user extracts the desired portion of the data from the hierarchical data file using an external software tool. The external software tool takes the entire hierarchical data file as an input. However, in some settings in which hierarchical data files are used, large amounts of data (e.g. multiple terabytes) may be stored in individual hierarchical data files. Such files may be too large for a user to process or analyze at a client computing device, since the amount of memory required to store a large hierarchical data file may exceed the hardware capabilities of the client computing device. Thus, the user may be unable to locally process the desired portions of the hierarchical data file. In addition, the hierarchical data file may be difficult to search, with the user having to perform separate searches for each data type when the hierarchical data file stores data with multiple different types. Retrieving desired data according to existing methods of processing hierarchical data files may therefore be difficult for the user.

For example, in greenhouse gas emissions monitoring applications, large amounts of data across multiple sensor types may be collected and stored in hierarchical data files. The data stored in the hierarchical data files may indicate quantities associated with any of Scope 1, Scope 2, and/or Scope 3 emissions. Scope 1 emissions are emissions that occur as direct consequences of activities owned or controlled by the emitter organization. Scope 2 emissions are emissions associated with electricity, heat, steam, or cooling purchased by the emitter organization. Scope 3 emissions are emissions that occur indirectly as results of the organization's activities at sources that the organization does not own or control, and which are not included in Scope 2. Hierarchical data files storing emissions data may be used by greenhouse gas emitter organizations or by other users such as independent auditor organizations or customers of emitter organizations.

When monitoring greenhouse gas emissions using data stored in hierarchical data files, the above problems in retrieving and analyzing the data stored in the hierarchical data files may make it difficult for emitter organizations or other users to track the quantities of greenhouse gas emissions associated with their activities. Other types of processing performed on the emissions data, such as to identify sources of anomalous increases in emissions, may also be difficult due to high memory requirements and lack of cross-data-type search functionality.

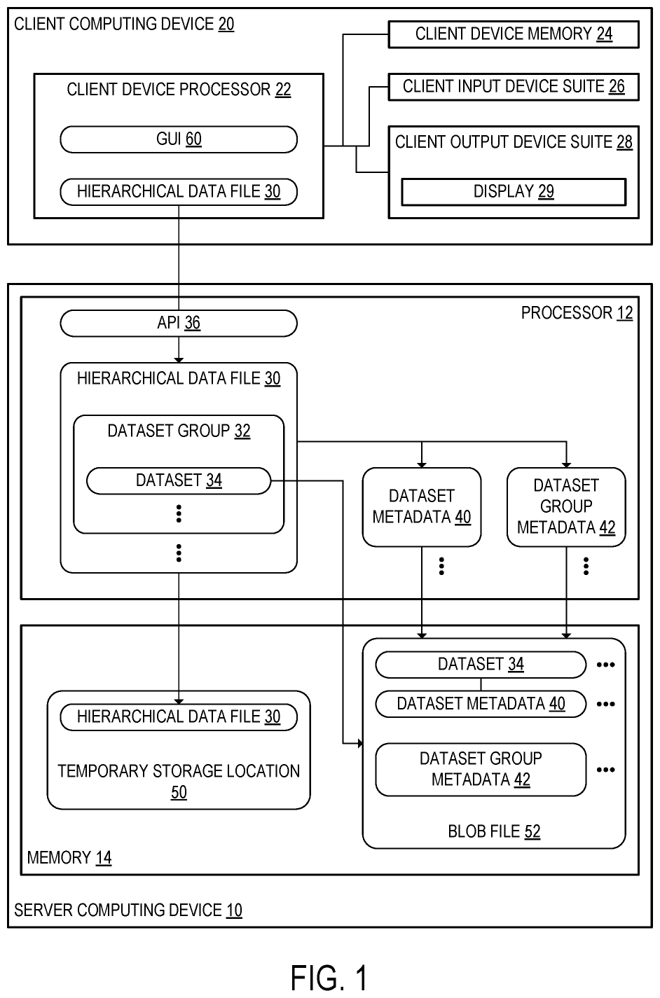

In order to address the above difficulties, a server computing device 10 is provided, as shown schematically in FIG. 1 according to one example embodiment. As shown in FIG. 1, the server computing device 10 may include a processor 12 and memory 14. The server computing device 10 may be configured to communicate with one or more other computing devices, such as the client computing device 20. The server computing device 10 may further include other hardware components not shown in FIG. 1, such as one or more input devices or one or more output devices.

In some examples, the server computing device 10 may be instantiated in a plurality of communicatively linked computing devices rather than in a single physical computing device. For example, components of the server computing device 10 may be distributed between a plurality of physical computing devices located in a data center and connected via a wired network. Processes executed at the processor 12 may be distributed between the respective processors of the plurality of communicatively linked computing devices. In addition, data stored in the memory 14 may be distributed between a plurality of memory devices located at different physical devices.

In the example of FIG. 1, the client computing device 20 includes a client device processor 22 that is configured to communicate with client device memory 24. The example client computing device 20 of FIG. 1 further includes a client input device suite 26 that includes one or more input devices and a client output device suite 28 that includes one or more output devices. The client output device suite 28 includes a display 29 in the example of FIG. 1. The client device processor 22 may be configured to implement a graphical user interface (GUI) 60 via which information may be displayed on the display 29. In addition, the user may interact with interactable elements displayed at the GUI 60 using the one or more input devices included in the client input device suite 26.

The processor 12 of the server computing device 10 may be configured to implement an application program interface (API) 36 to allow the client computing device 20 to upload hierarchical data files 30 to the server computing device 10, download data included in the hierarchical data files 30 from the server computing device 10, and process the data included in the hierarchical data files 30 while that data is stored remotely. In a dataset ingestion phase, the processor 12 may be configured to receive a hierarchical data file 30 via the API 36. Hierarchical Data Format 5 (HDF5) is one example of a hierarchical data file format in which the processor 12 may receive the hierarchical data file 30. Alternatively, the hierarchical data file 30 may have some other format that has a rich metadata system. For example, the hierarchical data file 30 may be a Zarr file, a JavaScript Object Notation (JSON) file, or an Extensible Markup Language (XML) file.

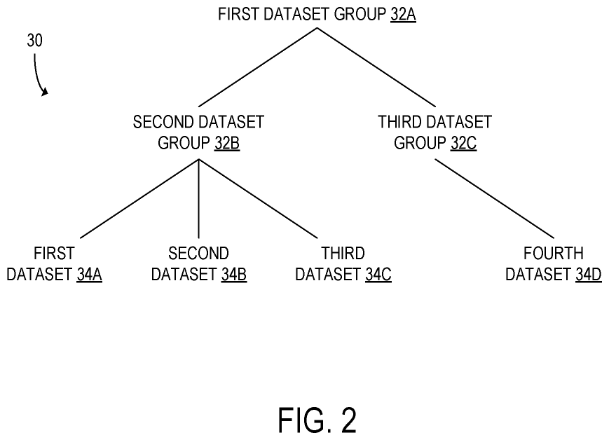

The hierarchical data file 30 may include a plurality of datasets 34 that are hierarchically organized in a plurality of dataset groups 32. Thus, the hierarchical data file 30 may be structured as a container. In the hierarchical data file 30, a dataset group 32 may include one or more other dataset groups 32 additionally or alternatively to including one or more datasets 34. The hierarchical structure of an example hierarchical data file 30 is schematically shown in FIG. 2. In the example of FIG. 2, the hierarchical data file 30 includes a first dataset group 32A that includes a second dataset group 32B and a third dataset group 32C. The second dataset group 32B includes a first dataset 34A, a second dataset 34B, and a third dataset 34C. The third dataset group 32C includes a fourth dataset 34D.

Returning to FIG. 1, in the dataset ingestion phase, the processor 12 may be further configured to store the hierarchical data file 30 at a temporary storage location 50 in the memory 14. While the hierarchical data file 30 is stored at the temporary storage location 50, the processor 12 may be further configured to assign respective dataset metadata 40 to the plurality of datasets 34 and respective dataset group metadata 42 to the plurality of dataset groups 32. The dataset metadata 40 and the dataset group metadata 42 may accordingly specify the hierarchical structure of the hierarchical data file 30. Other properties of the plurality of datasets 34 and the plurality of dataset groups 32, such as a file size or a timestamp, may additionally be included in the dataset metadata 40 and the dataset group metadata 42, respectively. The dataset metadata 40 and the dataset group metadata 42 may be expressed in JSON files or XML files in some examples.

The plurality of datasets 34 included in the hierarchical data file 30 may include data of disparate data types. For example, the hierarchical data file 30 may include one or more datasets 34 that include time series data and may further include one or more datasets 34 that include data that is not organized into a time series. In some examples, the data type of the data included in each dataset 34 may be indicated in the dataset metadata 40 for that dataset 34.

The dataset metadata 40 may indicate a flat file structure of the hierarchical data file 30 and the dataset group metadata 42 may indicate a hierarchical file structure of the hierarchical data file 30. An example of a flat file structure in the form of a JSON file is provided below:

[
“testingPackageCpp/RESQML/17f1430e-0cf7-4bca-b45f-
ab999a2be715/SupportingRepresentationNodes_contact0_patch0”,
“testingPackageCpp/RESQML/17f1430e-0cf7-4bca-b45f-
ab999a2be715/SupportingRepresentationNodes_contact0_patch1”,
“testingPackageCpp/RESQML/17f1430e-0cf7-4bca-b45f-
ab999a2be715/SupportingRepresentationNodes_contact0_patch2”,
“testingPackageCpp/RESQML/4b3f4bfd-290f-416e-abb6-
a607fb18f232/points_patch0”,
“testingPackageCpp/RESQML/5c2df99c-c258-4794-9183-
5720fbddd6f2/points_patch0”,
“testingPackageCpp/RESQML/b2d23913-4527-4e21-965c-
880ad70d68ed/SupportingRepresentationNodes_contact0_patch0”,
“testingPackageCpp/RESQML/b2d23913-4527-4e21-965c-
880ad70d68ed/SupportingRepresentationNodes_contact0_patch1”,
“testingPackageCpp/RESQML/b2d23913-4527-4e21-965c-
880ad70d68ed/SupportingRepresentationNodes_contact0_patch2”,
“testingPackageCpp/RESQML/bc4ed979-5584-4326-9b18-d7383605d39d”,
“testingPackageCpp/RESQML/cde9956c-0f3a-4b77-a173-5a2b4b8a67e4”,
“testingPackageCpp/RESQML/f75f954a-1108-4669-b701-5d7b5b4a3f01”,
“testingPackageCpp/RESQML”
]

In addition, an example of a hierarchical file structure in the form of a JSON file is provided below:

{″testingPackageCpp/RESQML″: // HDF5: Group Name
[″testingPackageCpp/RESQML/17f1430e-0cf7-4bca-b45f-ab999a2be715″, // HDF5:
DataSet
″testingPackageCpp/RESQML/4b3f4bfd-290f-416e-abb6-a607fb18f232″,
″testingPackageCpp/RESQML/5c2df99c-c258-4794-9183-5720fbddd6f2″,
″testingPackageCpp/RESQML/5d27775e-5c7f-4786-a048-9a303fa1165a”],
″testingPackageCpp/RESQML/17f1430e-0cf7-4bca-b45f-ab999a2be715″:
[″testingPackageCpp/RESQML/17f1430e-0cf7-4bca-b45f-
ab999a2be715/SupportingRepresentationNodes_contact0_patch0″,
″testingPackageCpp/RESQML/17f1430e-0cf7-4bca-b45f-
ab999a2be715/SupportingRepresentationNodes_contact0_patch1″,
″testingPackageCpp/RESQML/17f1430e-0cf7-4bca-b45f-
ab999a2be715/SupportingRepresentationNodes_contact0_patch2],
.....
}

In the above examples, the hierarchical data file 30 from which the dataset metadata 40 and the dataset group metadata 42 is generated is an HDF5 file.

In some examples, the dataset metadata 40 and the dataset group metadata 42 may be generated at the server computing device 10. In such examples, the dataset metadata 40 and the dataset group metadata 42 may be generated while the hierarchical data file 30 is stored at the temporary storage location 50. Alternatively, the processor 12 may be configured to receive the dataset metadata 40 and the dataset group metadata 42 from the client computing device 20. In some examples, when the processor 12 receives the dataset metadata 40 and the dataset group metadata 42 from the client computing device 20, the processor 12 may be configured to receive the dataset metadata 40 and the dataset group metadata 42 via a post request made to the API 36 by the client computing device 20. Alternatively, the processor 12 may be configured to receive the dataset metadata 40 and the dataset group metadata 42 by performing an API call to access a filesystem cloud storage location to which the user of the client computing device 20 has uploaded the dataset metadata 40 and the dataset group metadata 42.

The processor 12 may be further configured to store, in the memory 14, the plurality of datasets 34, the dataset metadata 40, and the dataset group metadata 42. After the plurality of datasets 34, the dataset metadata 40, and the dataset group metadata 42 have been stored in the memory 14, the processor 12 may be further configured to delete the hierarchical data file 30 from the temporary storage location 50. Thus, at the processor 12, the hierarchical data file 30 may be converted into a “shredded” form in which individual datasets 34 may be accessed separately. The plurality of datasets, the dataset metadata 40, and the dataset group metadata 42 may be stored in a form that allows the original hierarchical data file 30 to be reconstructed from the plurality of datasets 34, the dataset metadata 40, and the dataset group metadata 42. In some examples, the plurality of datasets 34, the dataset metadata 40, and the dataset group metadata 42 may be stored in the memory 14 as a binary large object (blob) file 52. In some examples, the blob file 52 may be stored in a sharded and parallelized form in which the blob file 52 is distributed across a plurality of server instances.

In some examples, alternatively to storing the hierarchical data file 30 at a temporary storage location 50 and later deleting the hierarchical data file 30 from the temporary storage location 50 after the datasets 34, the dataset metadata 40, and the dataset group metadata 42 have been stored in the memory 14, the processor 12 may instead be configured to generate the dataset metadata 40 and the dataset group metadata 42 “on the fly.” In such examples, the processor 12 may be configured to generate the blob file 52 including the plurality of datasets 34, the dataset metadata 40, and the dataset group metadata 42 directly from the hierarchical data file 30 as the hierarchical data file 30 is received. “On the fly” generation of the blob file 52 may be performed when a file size of the hierarchical data file 30 is below a size threshold. In addition, the blob file 52 may be generated “on the fly” when the hierarchical data file 30 is received in the form of a plurality of hierarchical data file chunks, as discussed in further detail below.

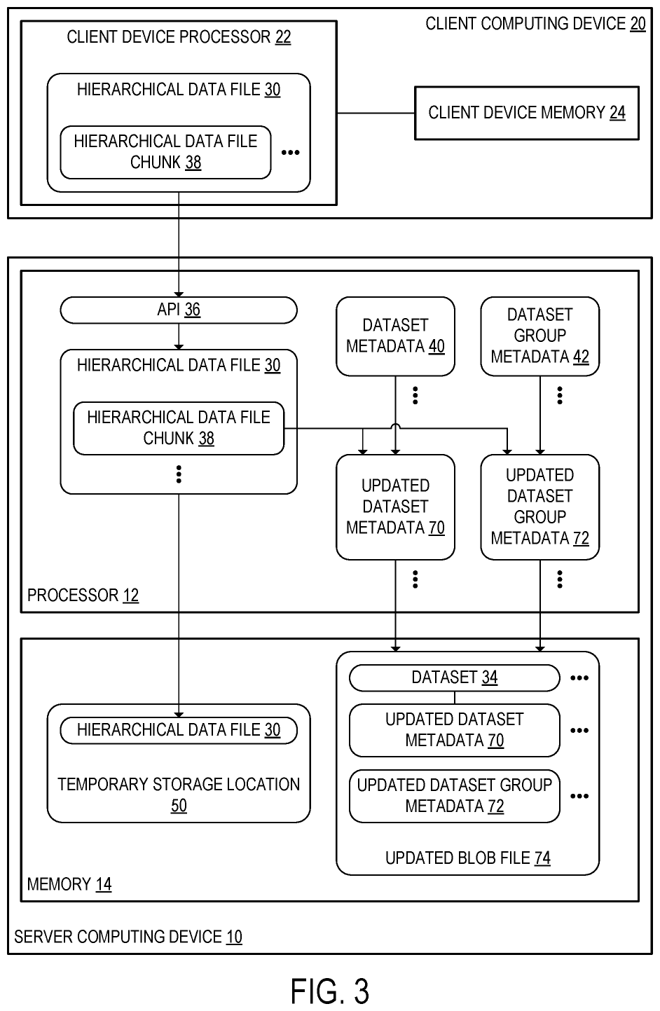

In some examples, as shown in FIG. 3, the processor 12 may be configured to receive the hierarchical data file 30 in a plurality of uploading iterations in which a respective plurality of hierarchical data file chunks 38 are streamed to the server computing device 10. In such examples, the processor 12 may be further configured to store the plurality of hierarchical data file chunks 38 at the temporary storage location 50. Thus, the processor 12 may be configured to add to the hierarchical data file 30 as additional data is received over time. The processor 12 may be further configured to update the dataset metadata 40 for at least one dataset 34 of the plurality of datasets 34 in each uploading iteration of the plurality of uploading iterations. In addition, the processor 12 may be further configured to update the dataset group metadata 42 when a hierarchical data file chunk 38 is received. Thus, the processor 12 may be configured to generate updated dataset metadata 70 and updated dataset group metadata 72 during the uploading iteration. The processor 12 may be further configured to generate an updated blob file 74 located in the memory 14 that stores the plurality of datasets 34, as encoded by the plurality of hierarchical data file chunks 38, along with the updated dataset metadata 70 and the updated dataset group metadata 72.

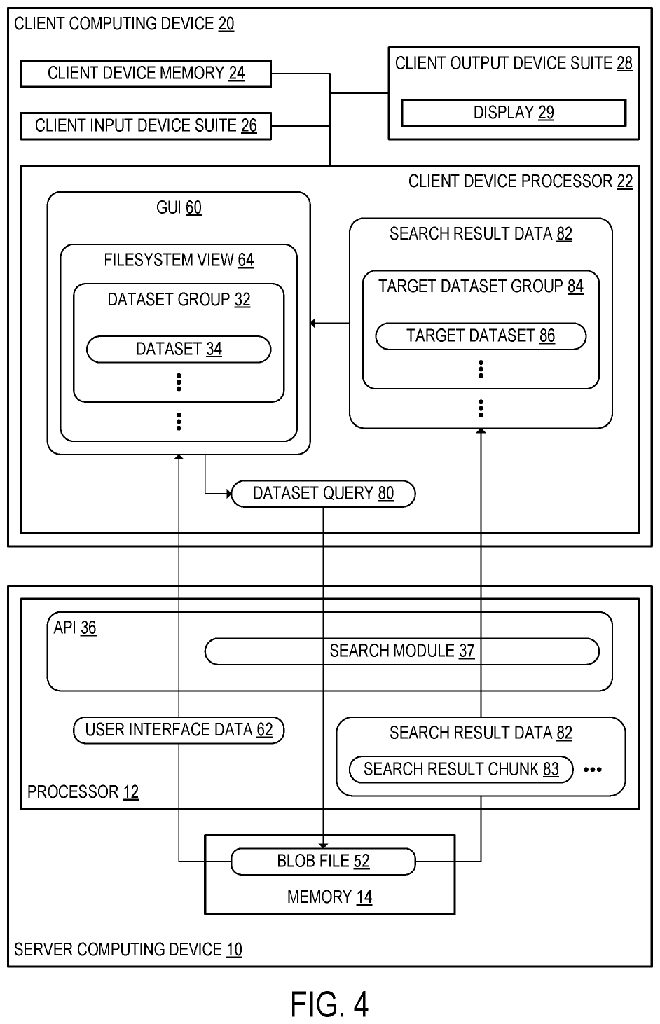

Turning now to FIG. 4, the server computing device 10 and the client computing device 20 are shown during a dataset query phase. In the dataset query phase, the processor 12 may be further configured to receive a dataset query 80 from the client computing device 20. The user of the client computing device 20 may initiate the dataset query 80 by entering a user input at the GUI 60 using the one or more input devices of the client input device suite 26. The search query 80 may be received and processed at a search module 37 included in the API 36. In some examples, the dataset query 80 may indicate at least a portion of the dataset metadata 40 and/or at least a portion of the dataset group metadata 42. For example, the dataset query 80 may be a query for data collected during a specific time interval or in a specific geographic region. The dataset query 80 may identify one or more target datasets 86 among the plurality of datasets 34. Additionally or alternatively, the dataset query 80 may identify one or more target dataset groups 84 among the plurality of dataset groups 32.

In response to receiving the dataset query 80, the processor 12 may be further configured to perform a search over the dataset metadata 40 and/or the dataset group metadata 42 to thereby generate search results 82. In some examples, the search module 37 may be configured to convert the dataset query 80 received at the GUI 60 into a form in which the dataset query 80 may be compared directly to the dataset metadata 40 and the dataset group metadata 42 in order to identify, as the search results 82, one or more datasets 34 with metadata that corresponds to the search query 80. The search results 82 may, for example, take the form of a ranked list. The search results 82 may be retrieved from the blob file 52 in examples in which the datasets 34, dataset metadata 40, and dataset group metadata 42 are stored in a blob file 52. In examples in which the dataset query 80 identifies one or more target datasets 86, the search may be performed over dataset metadata 40 and/or dataset group metadata 42 corresponding to the one or more target datasets 86.

In response to generating the search results 82, the processor 12 may be further configured to transmit the search results 82 to the client computing device 20 via the API 36. The search results 82 may be transmitted to the client computing device 20 by the search module 37. The processor 12 may, in some examples, be configured to transmit the search results 82 to the client computing device in a plurality of search result outputting iterations in which a respective plurality of search result chunks 83 are streamed to the client computing device 20.

In some examples, the processor 12 may be further configured to transmit user interface data 62 for the hierarchical data file 30 to the client computing device 20 for display in the GUI 60. The user interface data 62 may indicate the plurality of datasets 34 hierarchically organized into the plurality of dataset groups 32 as specified by the dataset group metadata 42. Accordingly, the processor 12 may provide a graphical representation of the hierarchical data file 30 to the user of the client computing device 20. The user interface data 62 for the hierarchical data file 30 may, in some examples, encode one or more interactable GUI elements via which the user of the client computing device 20 may enter the dataset query 80. In addition, the GUI 60 may include one or more interactable GUI elements via which the user of the client computing device 20 may upload data for inclusion in the hierarchical data file 30. Thus, via the API 36, the server computing device 10 may provide the user with a tool for interacting with the hierarchical data file 30 from the client computing device 20.

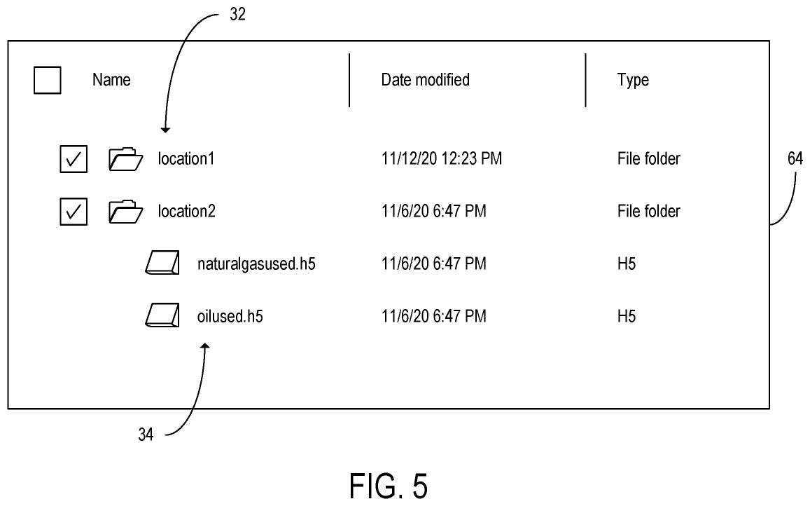

FIG. 5 shows an example of a filesystem view 64 of the hierarchical data file 30 that may be displayed as part of the GUI 60. In the filesystem view 64, the dataset groups 32 included in the hierarchical data file 30 are shown as folders, and the datasets 34 included in the hierarchical data file 30 are shown as files located in those folders. Accordingly, the user of the client computing device 20 may view and interact with the datasets 34 and dataset groups 32 of the hierarchical data file 30 as though the datasets 34 and dataset groups 32 were stored locally on the client computing device 20 as files and folders, respectively. Thus, the filesystem encoded in the datasets 34 and dataset groups 32 of the hierarchical data file 30 may be mounted at the client computing device 20.

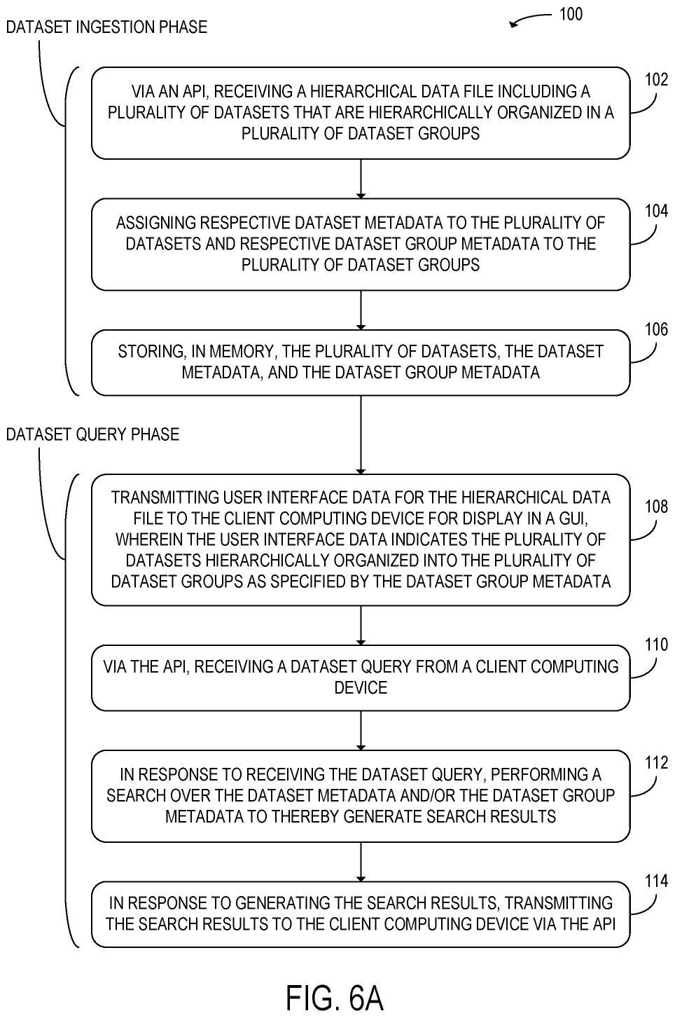

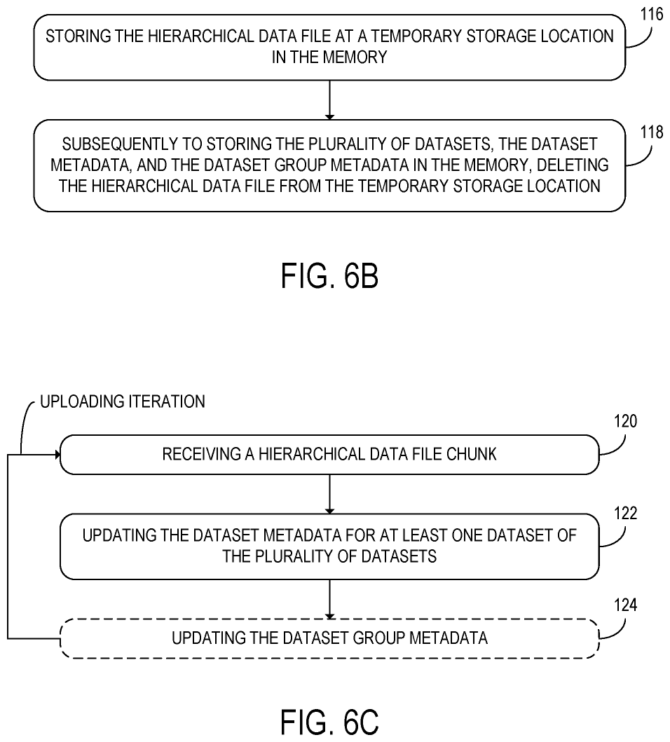

FIG. 6A shows a flowchart of an example method 100 for use at a server computing device. The method 100 may be used with the server computing device 10 of FIG. 1 or with some other server computing device. The method 100 includes a dataset ingestion phase and a dataset query phase. In the dataset ingestion phase, the method 100 may include, at step 102, receiving a hierarchical data file including a plurality of datasets that are hierarchically organized in a plurality of dataset groups. The hierarchical data file may be received via an API executed at the server computing device. The hierarchical data file may, for example, be a Hierarchical Data Format 5 (HDF5) file, a Zarr file, a JSON file, and XML file, or some other type of file that has a rich metadata system. In some examples, the data included in the hierarchical data file may differ in data type between datasets.

At step 104, the method 100 may further include assigning respective dataset metadata to the plurality of datasets and respective dataset group metadata to the plurality of dataset groups. The dataset metadata and the dataset group metadata may respectively indicate the hierarchical structure of the hierarchical data file. In addition, the dataset metadata and the dataset metadata may indicate additional properties of the plurality of datasets and the plurality of dataset groups, such as a file size of a dataset or dataset group or a timestamp of a time at which a dataset or dataset group was created or most recently modified. The dataset metadata and the dataset group metadata may, for example, be included in one or more JSON files. The dataset metadata and the dataset group metadata may be generated at the server computing device or may alternatively be received from the client computing device via the API. At step 106, the method 100 may further include storing, in the memory, the plurality of datasets, the dataset metadata, and the dataset group metadata. For example, the plurality of datasets, the dataset metadata, and the dataset group metadata may be stored in the memory as a blob file. The blob file may, for example, be stored in a sharded and parallelized form across a plurality of server instances.

Step 108 of the method 100 may be performed in a dataset query phase. At step 108, the method may further include transmitting user interface data for the hierarchical data file to the client computing device for display in a GUI. The user interface data may indicate the plurality of datasets hierarchically organized into the plurality of dataset groups as specified by the dataset group metadata. For example, the user interface data may encode a filesystem view in which the plurality of dataset groups are displayed as folders and the plurality of datasets are displayed as files located within those folders. The GUI may include one or more interactable elements via which the user of the client computing device may transmit instructions to the server computing device via the API.

In the dataset query phase, the method 100 may further include, at step 110, receiving a dataset query from a client computing device. The dataset query may be received via the API. In some examples, the dataset query may indicate at least a portion of the dataset metadata and/or at least a portion of the dataset group metadata. Additionally or alternatively, the dataset query may identify one or more target datasets among the plurality of datasets or one or more target dataset groups among the plurality of dataset groups. At step 112, the method 100 may further include performing a search over the dataset metadata and/or the dataset group metadata to thereby generate search results in response to receiving the dataset query. In examples in which the dataset query indicates at least a portion of the dataset metadata and/or at least a portion of the dataset group metadata, the search result may include one or more datasets and/or one or more dataset groups included in the hierarchical data file that match the metadata indicated in the dataset query. In examples in which the dataset query identifies one or more target datasets, the search may be performed over dataset metadata and/or dataset group metadata corresponding to the one or more target datasets.

At step 114, the method 100 may further include transmitting the search results to the client computing device via the API in response to generating the search results. In some examples, the search results may be transmitted to the client computing device in a plurality of search result outputting iterations in which a respective plurality of search result chunks are streamed to the client computing device. In examples in which step 108 is performed, the search results may be transmitted to the client computing device as user interface data for display in the GUI. Accordingly, one or more datasets included in the hierarchical data file may be made accessible to the user of the client computing device without the user having to download the entire hierarchical data file. The one or more datasets included in the search results may, for example, be presented in the filesystem view of the hierarchical data file.

FIG. 6B shows additional steps of the method 100 that may be performed in some examples during the dataset ingestion phase. In such examples, during the dataset ingestion phase, the method 100 may further include, at step 116, storing the hierarchical data file at a temporary storage location in memory. In examples in which step 116 is performed, the method 100 may further include, at step 118, deleting the hierarchical data file from the temporary storage location. In examples in which step 116 is not performed, a blob file including the plurality of datasets, the dataset metadata, and the dataset group metadata may be generated “on the fly” without first storing the hierarchical data file in a temporary storage location. The blob file may also be generated “on the fly” when the hierarchical data file is received in a plurality of hierarchical data file chunks.

FIG. 6C shows steps of the method 100 that may be performed in some examples during the dataset ingestion phase when the hierarchical data file is received and the dataset metadata and dataset group metadata are assigned. In the example of FIG. 6C, the hierarchical data file is received in a plurality of uploading iterations in which a respective plurality of hierarchical data file chunks are streamed to the server computing device. At step 120, the method 100 may include receiving a hierarchical data file chunk. At step 122, the method 100 may further include updating the dataset metadata for at least one dataset of the plurality of datasets. Step 120 and step 122 may be performed in each uploading iteration of the plurality of uploading iterations. In some uploading iterations, the method 100 may further include, at step 124, updating the dataset group metadata. Thus, in each uploading iteration, the dataset metadata and dataset group metadata for the hierarchical data file may be updated when applicable to reflect changes to the plurality of datasets and/or the hierarchical structure.

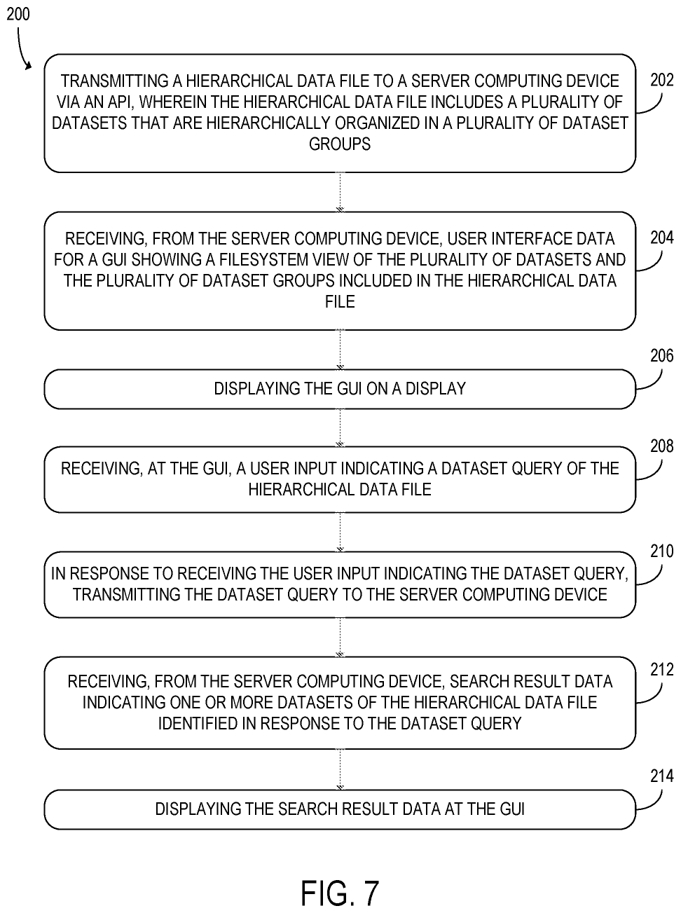

FIG. 7 shows a flowchart of a method 200 for use with a client computing device. The method 200 may be used with the client computing device 20 of FIG. 1 or with some other client computing device. At step 202, the method 200 may include transmitting a hierarchical data file to a server computing device via an API. The hierarchical data file may include a plurality of datasets that are hierarchically organized in a plurality of dataset groups. The hierarchical data file may, for example, be an HDF5 file. Alternatively, the hierarchical data file may have some other file type such as Zarr, JSON, or XML. In some examples, the hierarchical data file may be streamed to the server computing device in a plurality of uploading iterations in which the client computing device transmits corresponding hierarchical data file chunks to the server computing device. In some examples, the hierarchical data file may include datasets of data with disparate data types. For example, the hierarchical data file may include one or more datasets of time series data and one or more datasets of data that is not organized in a time series.

At step 204, the method 200 may further include receiving, from the server computing device, user interface data for a GUI showing a filesystem view of the plurality of datasets and the plurality of dataset groups included in the hierarchical data file. At step 206, the method 200 may further include displaying the GUI on the display. In the GUI, the plurality of datasets of the hierarchical data file may be hierarchically organized into the plurality of dataset groups as specified by the dataset group metadata.

At step 208, the method 200 may further include receiving, at the GUI, a user input indicating a dataset query of the hierarchical data file. The user input may be entered at one or more interactable elements included in the GUI, via one or more input devices included in an input device suite of the client computing device. For example, the dataset query may indicate at least a portion of the dataset metadata and/or at least a portion of the dataset group metadata. Additionally or alternatively, the dataset query may identify one or more target datasets among the plurality of datasets. In response to receiving the user input indicating the dataset query, the method 200 may further include, at step 210, transmitting the dataset query to the server computing device.

At step 212, the method 200 may further include receiving, from the server computing device, search result data indicating one or more datasets of the hierarchical data file identified in response to the dataset query. In examples in which the dataset query indicates at least a portion of the dataset metadata and/or at least a portion of the dataset group metadata, the search result data may include one or more datasets or dataset groups with metadata matching the portion of metadata indicated in the dataset query. In examples in which the dataset query identifies one or more target datasets, the search result data may include those one or more target datasets. The search result data may, in some examples, be received in a plurality of search result chunks that are sent to the client computing device in a respective plurality of search result outputting iterations. At step 214, the method 200 may further include displaying the search result data at the GUI. For example, the search result data may be displayed in a filesystem view mounted at the client computing device. In the filesystem view, the one or more datasets included in the search results may be displayed as files stored in one or more folders. Thus, the search results may be viewable by the user of the client computing device.

According to one example use case scenario, a hierarchical data file may be generated from sensor data collected at a plurality of depths in an oil well. At each of the plurality of depths, a corresponding set of sensors may measure quantities such as temperature, pressure, and conductivity. In addition, the sensor data collected at each of the sensors may be time series data in which measurements occur at a predetermined time interval. Thus, in the hierarchical data file, the datasets may be organized into a hierarchical structure with levels corresponding to depths, times, and individual sensors. When, for example, a user wishes to analyze data collected during a specific time interval within a specific range of depths, the user may enter a dataset query for sensor data collected in that time interval and depth range. The user may access such sensor data at the client computing device without having to download the entire hierarchical data file. Thus, the user may process the desired data at the client computing device without having to use large amounts of memory to store the hierarchical data file.

In another example use case scenario, a user who is considering purchasing a product or service from a company that uses hierarchical data files to track its greenhouse-gas-emitting activities may enter a dataset query for emissions data associated with that particular product or service. Rather than downloading the entire hierarchical data file, which may be impractical due to memory constraints of the client computing device, the user may indicate dataset metadata related to the specific product or service when entering the search query. Thus, in response to the search query, the server computing device may send the user the dataset that includes data related to the greenhouse gas emissions associated with that product or service. The user may thereby access greenhouse gas emissions data that would otherwise be difficult to access, and may view and analyze that greenhouse gas emissions data to inform the purchasing decision.

In addition, the data included in the plurality of datasets of the hierarchical data file may have different data types. In the example in which the hierarchical data file includes sensor data measured at different depths in an oil well, the data types may correspond to the variables such as temperature, pressure, and conductivity that are measured by the sensors. At the GUI provided via the API, the user may perform a search over a plurality of different data types at once and may accordingly retrieve the desired data from the hierarchical data file without having to perform multiple searches for data with each of the respective data types. Thus, the API may allow the user to more easily access the data stored in a hierarchical data file when the hierarchical data file includes data with a plurality of different data types.

In some embodiments, the methods and processes described herein may be tied to a computing system of one or more computing devices. In particular, such methods and processes may be implemented as a computer-application program or service, an application-programming interface (API), a library, and/or other computer-program product.

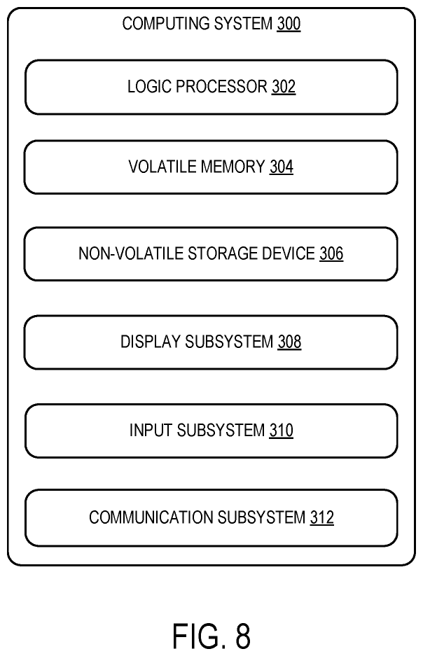

FIG. 8 schematically shows a non-limiting embodiment of a computing system 300 that can enact one or more of the methods and processes described above. Computing system 300 is shown in simplified form. Computing system 300 may embody the server computing device 10 described above and illustrated in FIG. 1. One or more components of the computing system 300 may be instantiated in one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 300 includes a logic processor 302 volatile memory 304, and a non-volatile storage device 306. Computing system 300 may optionally include a display subsystem 308, input subsystem 310, communication subsystem 312, and/or other components not shown in FIG. 8.

Logic processor 302 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 302 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 306 includes one or more physical devices configured to hold instructions executable by the logic processors to implement the methods and processes described herein. When such methods and processes are implemented, the state of non-volatile storage device 306 may be transformed—e.g., to hold different data.

Non-volatile storage device 306 may include physical devices that are removable and/or built-in. Non-volatile storage device 306 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by logic processor 302 to temporarily store information during processing of software instructions. It will be appreciated that volatile memory 304 typically does not continue to store instructions when power is cut to the volatile memory 304.

Aspects of logic processor 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via logic processor 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with logic processor 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 300 to send and/or receive messages to and/or from other devices via a network such as the Internet.

The following paragraphs discuss several aspects of the present disclosure. According to one aspect of the present disclosure, a server computing device including a processor is provided. In a dataset ingestion phase, via an application program interface (API), the processor may be configured to receive a hierarchical data file including a plurality of datasets that are hierarchically organized in a plurality of dataset groups. The processor may be further configured to assign respective dataset metadata to the plurality of datasets and respective dataset group metadata to the plurality of dataset groups. The processor may be further configured to store, in memory, the plurality of datasets, the dataset metadata, and the dataset group metadata. In a dataset query phase, via the API, the processor may be further configured to receive a dataset query from a client computing device. In response to receiving the dataset query, the processor may be further configured to perform a search over the dataset metadata and/or the dataset group metadata to thereby generate search results. In response to generating the search results, the processor may be further configured to transmit the search results to the client computing device via the API.

According to this aspect, the hierarchical data file may be a Hierarchical Data Format 5 (HDF5) file.

According to this aspect, the dataset query may indicate at least a portion of the dataset metadata and/or at least a portion of the dataset group metadata.

According to this aspect, the dataset query may identify one or more target datasets among the plurality of datasets. The search may be performed over dataset metadata and/or dataset group metadata corresponding to the one or more target datasets.

According to this aspect, the processor may be configured to receive the hierarchical data file in a plurality of uploading iterations in which a respective plurality of hierarchical data file chunks are streamed to the server computing device.

According to this aspect, the processor may be further configured to update the dataset metadata for at least one dataset of the plurality of datasets in each uploading iteration of the plurality of uploading iterations.

According to this aspect, the processor may be configured to transmit the search results to the client computing device in a plurality of search result outputting iterations in which a respective plurality of search result chunks are streamed to the client computing device.

According to this aspect, the plurality of datasets, the dataset metadata, and the dataset group metadata may be stored in the memory as a binary large object (blob) file.

According to this aspect, the processor may be further configured to transmit user interface data for the hierarchical data file to the client computing device for display in a graphical user interface (GUI). The user interface data may indicate the plurality of datasets hierarchically organized into the plurality of dataset groups as specified by the dataset group metadata.

According to this aspect, the processor may be further configured to, in the dataset ingestion phase, store the hierarchical data file at a temporary storage location in the memory. Subsequently to storing the plurality of datasets, the dataset metadata, and the dataset group metadata in the memory, the processor may be further configured to delete the hierarchical data file from the temporary storage location.

According to another aspect of the present disclosure, a method for use at a server computing device is provided. In a dataset ingestion phase, via an application program interface (API), the method may include receiving a hierarchical data file including a plurality of datasets that are hierarchically organized in a plurality of dataset groups. The method may further include assigning respective dataset metadata to the plurality of datasets and respective dataset group metadata to the plurality of dataset groups. The method may further include storing, in memory, the plurality of datasets, the dataset metadata, and the dataset group metadata. In a dataset query phase, via the API, the method may further include receiving a dataset query from a client computing device. In response to receiving the dataset query, the method may further include performing a search over the dataset metadata and/or the dataset group metadata to thereby generate search results. In response to generating the search results, the method may further include transmitting the search results to the client computing device via the API.

According to this aspect, the hierarchical data file may be a Hierarchical Data Format 5 (HDF5) file.

According to this aspect, the dataset query may indicate at least a portion of the dataset metadata and/or at least a portion of the dataset group metadata.

According to this aspect, the dataset query may identify one or more target datasets among the plurality of datasets. The search may be performed over dataset metadata and/or dataset group metadata corresponding to the one or more target datasets.

According to this aspect, the hierarchical data file may be received in a plurality of uploading iterations in which a respective plurality of hierarchical data file chunks are streamed to the server computing device.

According to this aspect, the method may further include updating the dataset metadata for at least one dataset of the plurality of datasets in each uploading iteration of the plurality of uploading iterations.

According to this aspect, the plurality of datasets, the dataset metadata, and the dataset group metadata may be stored in the memory as a binary large object (blob) file.

According to this aspect, the method may further include transmitting user interface data for the hierarchical data file to the client computing device for display in a graphical user interface (GUI). The user interface data may indicate the plurality of datasets hierarchically organized into the plurality of dataset groups as specified by the dataset group metadata.

According to this aspect, during the dataset ingestion phase, the method may further include storing the hierarchical data file at a temporary storage location in the memory. Subsequently to storing the plurality of datasets, the dataset metadata, and the dataset group metadata in the memory, the method may further include deleting the hierarchical data file from the temporary storage location.

According to another aspect of the present disclosure, a client computing device is provided, including a processor configured to transmit a hierarchical data file to a server computing device via an application program interface (API). The hierarchical data file may include a plurality of datasets that are hierarchically organized in a plurality of dataset groups. The processor may be further configured to receive, from the server computing device, user interface data for a graphical user interface (GUI) showing a filesystem view of the plurality of datasets and the plurality of dataset groups included in the hierarchical data file. The processor may be further configured to display the GUI on a display. The processor may be further configured to receive, at the GUI, a user input indicating a dataset query of the hierarchical data file. In response to receiving the user input indicating the dataset query, the processor may be further configured to transmit the dataset query to the server computing device. The processor may be further configured to receive, from the server computing device, search result data indicating one or more datasets of the hierarchical data file identified in response to the dataset query. The processor may be further configured to display the search result data at the GUI.

“And/or” as used herein is defined as the inclusive or ∨, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A server computing device comprising:
a processor configured to:
in a dataset ingestion phase:
via an application program interface (API), receive a hierarchical data file including a plurality of datasets that are hierarchically organized in a plurality of dataset groups;
assign respective dataset metadata to the plurality of datasets and respective dataset group metadata to the plurality of dataset groups; and
store, in memory, the plurality of datasets, the dataset metadata, and the dataset group metadata; and
in a dataset query phase:
via the API, receive a dataset query from a client computing device;
in response to receiving the dataset query, perform a search over the dataset metadata and/or the dataset group metadata to thereby generate search results; and
in response to generating the search results, transmit the search results to the client computing device via the API.

2. The server computing device of claim 1, wherein the hierarchical data file is a Hierarchical Data Format 5 (HDF5) file.

3. The server computing device of claim 1, wherein the dataset query indicates at least a portion of the dataset metadata and/or at least a portion of the dataset group metadata.

4. The server computing device of claim 3, wherein:
the dataset query identifies one or more target datasets among the plurality of datasets; and
the search is performed over dataset metadata and/or dataset group metadata corresponding to the one or more target datasets.

5. The server computing device of claim 1, wherein the processor is configured to receive the hierarchical data file in a plurality of uploading iterations in which a respective plurality of hierarchical data file chunks are streamed to the server computing device.

6. The server computing device of claim 5, wherein the processor is further configured to update the dataset metadata for at least one dataset of the plurality of datasets in each uploading iteration of the plurality of uploading iterations.

7. The server computing device of claim 1, wherein the processor is configured to transmit the search results to the client computing device in a plurality of search result outputting iterations in which a respective plurality of search result chunks are streamed to the client computing device.

8. The server computing device of claim 1, wherein the plurality of datasets, the dataset metadata, and the dataset group metadata are stored in the memory as a binary large object (blob) file.

9. The server computing device of claim 1, wherein:
the processor is further configured to transmit user interface data for the hierarchical data file to the client computing device for display in a graphical user interface (GUI); and
the user interface data indicates the plurality of datasets hierarchically organized into the plurality of dataset groups as specified by the dataset group metadata.

10. The server computing device of claim 1, wherein the processor is further configured to, in the dataset ingestion phase:
store the hierarchical data file at a temporary storage location in the memory; and
subsequently to storing the plurality of datasets, the dataset metadata, and the dataset group metadata in the memory, delete the hierarchical data file from the temporary storage location.

11. A method for use at a server computing device, the method comprising:
in a dataset ingestion phase:
via an application program interface (API), receiving a hierarchical data file including a plurality of datasets that are hierarchically organized in a plurality of dataset groups;
assigning respective dataset metadata to the plurality of datasets and respective dataset group metadata to the plurality of dataset groups; and
storing, in memory, the plurality of datasets, the dataset metadata, and the dataset group metadata; and
in a dataset query phase:
via the API, receiving a dataset query from a client computing device;
in response to receiving the dataset query, performing a search over the dataset metadata and/or the dataset group metadata to thereby generate search results; and
in response to generating the search results, transmitting the search results to the client computing device via the API.

12. The method of claim 11, wherein the hierarchical data file is a Hierarchical Data Format 5 (HDF5) file.

13. The method of claim 11, wherein the dataset query indicates at least a portion of the dataset metadata and/or at least a portion of the dataset group metadata.

14. The method of claim 13, wherein:
the dataset query identifies one or more target datasets among the plurality of datasets; and
the search is performed over dataset metadata and/or dataset group metadata corresponding to the one or more target datasets.

15. The method of claim 11, wherein the hierarchical data file is received in a plurality of uploading iterations in which a respective plurality of hierarchical data file chunks are streamed to the server computing device.

16. The method of claim 15, further comprising updating the dataset metadata for at least one dataset of the plurality of datasets in each uploading iteration of the plurality of uploading iterations.

17. The method of claim 11, wherein the plurality of datasets, the dataset metadata, and the dataset group metadata are stored in the memory as a binary large object (blob) file.

18. The method of claim 11, further comprising transmitting user interface data for the hierarchical data file to the client computing device for display in a graphical user interface (GUI), wherein the user interface data indicates the plurality of datasets hierarchically organized into the plurality of dataset groups as specified by the dataset group metadata.

19. The method of claim 11, further comprising, during the dataset ingestion phase:
storing the hierarchical data file at a temporary storage location in the memory; and
subsequently to storing the plurality of datasets, the dataset metadata, and the dataset group metadata in the memory, deleting the hierarchical data file from the temporary storage location.

20. A client computing device comprising:
a processor configured to:
transmit a hierarchical data file to a server computing device via an application program interface (API), wherein the hierarchical data file includes a plurality of datasets that are hierarchically organized in a plurality of dataset groups;
receive, from the server computing device, user interface data for a graphical user interface (GUI) showing a filesystem view of the plurality of datasets and the plurality of dataset groups included in the hierarchical data file;
display the GUI on a display;
receive, at the GUI, a user input indicating a dataset query of the hierarchical data file;
in response to receiving the user input indicating the dataset query, transmit the dataset query to the server computing device;
receive, from the server computing device, search result data indicating one or more datasets of the hierarchical data file identified in response to the dataset query; and
display the search result data at the GUI.
